(19) United States
(12) Patent Application Publication
(10) Pub. No.: US 2024/0393519 A1
(43) Pub. Date: Nov. 28, 2024

(54) FRONT LIGHT GUIDE PLATE AND A REFLECTIVE DISPLAY

(71) Applicant: IRIS OPTRONICS CO., LTD., Tainan City (TW)

(72) Inventors: CHENG-YU LIN, Tainan City (TW); CHENG-HUNG YAO, Tainan City (TW); CHI-CHANG LIAO, Tainan City (TW)

(21) Appl. No.: 18/226,237

(22) Filed: Jul. 25, 2023

(30) Foreign Application Priority Data
May 22, 2023 (TW) 112118950

(51) Int. Cl. F21V 8/00

(52) U.S. Cl. CPC G02B 6/0036; G02B 6/0031; G02B 6/0091

(57) ABSTRACT

A front light guide plate and a reflective display are provided. The reflective display includes a front light guide plate, a light source and a display device, and the front light guide plate includes a first surface and a second surface corresponding to the first surface. A first surface includes a plurality of optical structures. Each optical structure includes a first optical surface, and a second optical surface disposed with the first optical surface in face-to-face fashion. The light source is implemented on the side of the front light guide plate, and the display device is provided with a second surface. When the light beams from the light source are reflected by the first optical surface of the front light guide plate and enter the display device, portion of the light beams emitted from the first optical surface to the second optical surface will be absorbed or scattered by the light reducing layer.

### BACKGROUND OF THE INVENTION

### 1. Field of the Invention

The invention relates to a front light guide plate and a reflective display, and, in particular, a front light guide plate and a reflective display which can mitigate the light leakage in the front light guide plate and to enhance the contrast.

### 2. Description of Related Art

In reflective displays, such as electronic paper, reflective LCD (RLCD), or cholesteric liquid crystal displays, a display light source is necessary when there is no external light available. For optimal performance and to achieve a high visual contrast between black and white, the reflective display requires a light source with high directionality. This ensures that the display exhibits excellent light reflection and overall display effect.

However, when a light guide plate is used to guide the light beam to the reflective display, light leakage can occur during the display process. This can result in diminished lighting effectiveness and uneven light distribution. Additionally, issues such as light spots, vignetting, or insufficient lighting may arise. These problems can lead to decreased image contrast, color distortion, and an overall poor visual experience for the users.

FIG. 1 illustrates a prior art display technology described in China Patent CN112805622B. The diagram shows a display 80, where solid lines represent light beams produced by a projection device 86. These light beams pass through a light guide plate 82, penetrate through a transparent screen 84, and reach the viewer's eye. Additionally, portion of the light beams leaking from the other side are blocked by a light-absorbing layer 88 to prevent side light leakage from affecting the visual experience. However, when the incident light angle does not meet the total reflection condition at the light-emitting surface, the light beams are not reflected by the transparent screen 84 but refracted out of the light guide plate 82. This leads to significant light leakage, resulting in the issues mentioned earlier. In other words, when the light beams are directly refracted towards the viewer's eye without passing through the transparent screen 84, the contrast ratio of the display 80 is diminished.

Therefore, to effectively overcome the issue of light leakage and enhance contrast, it is crucial to provide an optimal technical solution that effectively resolves the aforementioned challenges.

### SUMMARY OF THE INVENTION

The objective of the present invention is to provide a front light guide plate and a reflective display that addresses the issue of light leakage from the light guide plates in prior art. Furthermore, the invention aims to enhance the contrast of the reflective display, improving the viewing experience for users.

The present invention provides a front light guide plate comprising a plurality of optical structures implemented on a first surface. Each optical structure includes at least a first optical surface and a second optical surface, which are arranged in face-to-face fashion. Additionally, there is a first angle between the extension line of the first optical surface and the second surface, which is away from the first surface. The second optical surface and the first optical surface together form a groove on the first surface. Furthermore, the second optical surface is implemented with a light-reducing layer. Lastly, a second angle is formed between the extension line of the second optical surface and the second surface.

In addition, the lowest point of the first optical surface in the grooves are connected to the lowest point of the second optical surface in the grooves.

The grooves, with depths ranging from 3 to 10 micrometers, can be implemented in hole-like or trench-like structure. This means that the grooves can be arranged in a neat and organized structure, such as a checkerboard pattern, or in trench-like formation, resembling a washboard.

Furthermore, a flat surface is positioned between the optical structure and another neighboring optical structure. The two ends of the flat surface are connected respectively to the first optical surface and the second optical surface.

The first angle is in the range of 3 degrees to 60 degrees, while the second angle is in the range of 60 degrees to 100 degrees.

Furthermore, at least one light source can be positioned on at least one side of the front light guide plate. The light source can be a light-emitting diode (LED) or a cold cathode fluorescent lamp (CCFL), although it is not limited to these two devices. The light source emits light beams towards the front light guide plate, and it can be implemented on any side of the front light guide plate. Multiple light sources can be positioned on each side simultaneously. For instance, two, three, one, or two light sources can be implemented on the four sides respectively.

The second surface of the front light guide plate is further equipped with a display device. The light beams emitted by the light source are reflected by the first optical surface of the front light guide plate and enter the display device. The display device is a reflective display, which may include electronic papers, reflective LCDs, and cholesteric displays, and so on.

The light-reducing layer on the second optical surface is a material layer with either a high light absorption rate or high surface roughness. This layer is used to absorb or scatter a portion of the light beams emitted from the first optical surface onto the second optical surface. The light-reducing layer can be implemented using physical or chemical process methods.

Furthermore, the present invention also discloses a reflective display, which at least comprises a front light guide plate, at least one light source, and a display device.

The front light guide plate comprises a first surface and a second surface corresponding to the first surface, and a plurality of optical structures disposed on the first surface. Each optical structure consists of a first optical surface and a second optical surface. There is a first angle between the extension line of the first optical surface and the second surface. The optical surface is positioned in a face-to-face fashion with the second optical surface, and the first optical surface and the second optical surface together form a groove on the first surface. Additionally, the second optical surface incorporates a light-reducing layer. Lastly, a second angle is formed between the extension line of the second optical surface and the second surface.

At least one light source can be implemented on each side of the front light guide plate. The light source emits light beams towards the front light guide plate and can be either LCD or CCFL, although it is not limited to these options. This means that the light source can be positioned on any side of the front light guide plate, and multiple light sources can be arranged on a single side simultaneously. For instance, there can be two, three, one, or even two light sources arranged on the four sides.

The display device is disposed on the second surface of the front light guide plate, and the display device may be a reflective display, including but not limited to electronic paper, reflective LCD, and cholesteric display.

The light beams emitted from the light source are reflected by the first optical surface of the front light guide plate and enter the display device. However, a portion of the light beams emitted from the first optical surface and directed towards the second optical surface may be absorbed or scattered by the light reducing layer.

In the reflective display, the lowest point of the first optical surface in the groove is connected to the lowest point of the second optical surface in the groove.

The grooves, with depths ranging from 3 to 10 micrometers, can be implemented in hole-like or trench-like structure. This means that the grooves can be arranged in a neat and organized structure, such as a checkerboard pattern, or in trench-like pattern, resembling a washboard.

Furthermore, a flat surface is positioned between the optical structure and another neighboring optical structure. The two ends of the flat surface are connected respectively to the first optical surface and the second optical surface.

The first angle is in the range of 3 degrees to 60 degrees, while the second angle is in the range of 60 degrees to 100 degrees.

Therefore, the present invention provides a front light guide plate and a reflective display. Through the utilization of the optical structure comprising the first optical surface and the second optical surface, and the light reducing layer on the second optical surface, the present invention achieves uniform brightness and energy efficiency. Additionally, the present invention solves the issue of light leakage from the front light guide plate, leading to a substantial enhancement in the contrast of reflective displays and an improved visual experience for users.

The aforementioned illustrations are exemplary for the purpose of further explaining the scope of the present invention. Other objectives and advantages related to the present invention will be illustrated in the subsequent descriptions and appended drawings.

### BRIEF DESCRIPTION OF THE DRAWINGS

The foregoing features may be combined with the following drawings in various combinations without exclusivity, unless expressly indicated otherwise. Apparently, descriptions of drawings in the following may be some of embodiments of the present invention, those of ordinary skill in the art may derive other drawings based on the following drawings without unduly experiments.

FIG. 1 is a schematic diagram of a cholesteric liquid crystal display in the prior art;

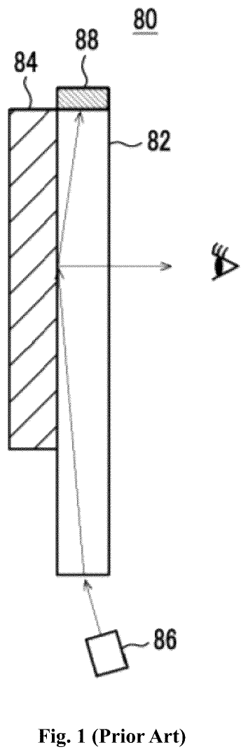

FIG. 2 is a schematic cross-sectional view of a reflective display in accordance with the present invention;

FIG. 3 is a schematic cross-sectional view of a front light guide plate in accordance with the present invention;

FIG. 4 is a top view of the first embodiment of the front light guide plate in accordance with the present invention;

FIG. 5 is a top view of the second embodiment of the front light guide plate in accordance with the present invention; and

FIGS. 6A to 6D are step-by-step schematic views of the manufacturing process of the front light guide plate in accordance with the present invention.

### DETAILED DESCRIPTION OF THE PREFERRED EMBODIMENTS

The aforementioned constructions and associated functions and following detailed descriptions are exemplary for the purpose of further explaining the scope of the present invention. Other objectives and advantages related to the present invention will be illustrated in the subsequent descriptions and appended drawings. Furthermore, the present invention may be embodied in various modifications, and descriptions and illustrations are not-limiting.

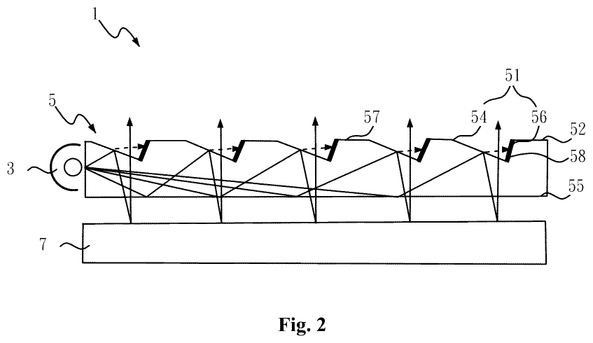

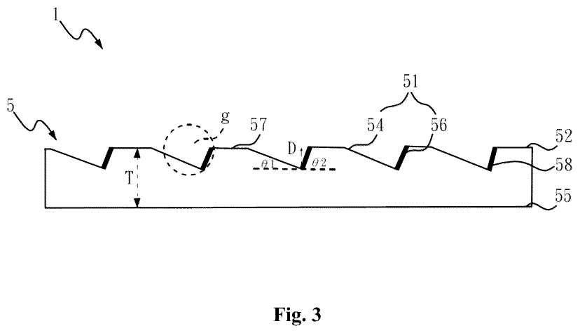

The present invention provides a front light guide plate and a reflective display to solve the issue of light leakage from the front light guide plate in the prior art. Please refer to FIG. 2 in conjunction with FIG. 3. FIG. 2 illustrates a schematic cross-sectional view of the reflective display in accordance with the present invention, while FIG. 3 depicts a schematic cross-sectional view of the front light guide plate in accordance with the present invention. The reflective display 1 of the present invention comprises a front light guide plate 5, at least one light source 3, and a display device 7. In this embodiment, the light source 3 is positioned at one side of the front light guide plate 5 for explanatory purposes.

The front light guide plate 5 consists of a first surface 52, a second surface 55 corresponding to the first surface 52, and multiple optical structures 51 arranged on the first surface 52. Each optical structure 51 is composed of a first optical surface 54 and a second optical surface 56 facing the first optical surface 54. The first angle θ1 is formed between the extension line of the first optical surface 54 and the second surface 55, while the second angle θ2 is formed between the extension line of the second optical surface 56 and the second surface 55. It should be noted that the first angle θ1 falls within the range of 3 degrees and 60 degrees, and the angle θ2 falls within the range of 60 degrees and 100 degrees. Additionally, a groove g is formed between the first optical surface 54 and the second optical surface 56.

A flat surface 57 is disposed between the optical structure 51 and another adjacent optical structure 51, and two ends of the flat surface 57 are respectively connected to the first optical surface 54 and the second optical surface 56.

The light source 3 can be positioned on at least one side of the front light guide plate 5 to serve as the light source for the reflective display 1. It emits light beams towards the front light guide plate 5, meaning that it can be located on any side of the front light guide plate 5. Additionally, multiple light sources 3 can be simultaneously placed on a single side. For instance, two, three, or even just one light source 3 can be individually positioned on each of the four sides. In this embodiment, only one light source 3 is present on one side.

The display device 7 is positioned on the second surface 55 of the front light guide plate 5. It is capable of reflecting light beams from the light source 3 in order to display images that are situated in front of the front light guide plate 5, thus providing a visual experience for viewers.

Please refer to the arrow shown in FIG. 2 again. The first optical surface 54 possesses the capability to redirect light beams. Specifically, it can completely reflect the light beams emitted by the light source 3 into the front light guide plate 5, subsequently emitting light beams towards the display device 7. Additionally, the display device 7 reflects the light beams once again, redirecting them towards the viewers' eyes. Regarding the second optical surface 56, it features a light-reducing layer 58. When the angle at which the light source 3 emits light beams onto the first optical surface 54 does not meet the conditions for total reflection and the refraction angle exceeds 90 degrees, the light beams are directly refracted from the first optical surface 54 and reach the light-reducing layer 58. The light-reducing layer 58 serves the purpose of blocking any light leakage paths and preventing the light beams from reaching the viewers' eyes. In other words, a portion of the light beams that are originally intended to be reflected by the second optical surface 56 from the first optical surface 54 will be absorbed or scattered by the light-reducing layer 58. This reduces the amount of light beams reflected by the second optical surface 56, thereby mitigating the issue of decreased contrast caused by light leakage and enhancing the viewing experience of the image displayed on the reflective display 1.

That means the light-reducing layer 58 in the front light guide plate 5 can take the form of a light-absorbing layer or a scattering layer. For instance, a light-absorbing material can be applied to the second optical surface 56 to create the light-absorbing layer. As an example, the light-absorbing layer could be a black film capable of absorbing all light. Alternatively, the scattering layer can be provided through physical or chemical treatment processes. The purpose of the scattering layer is to impart roughness to the second optical surface 56. This enables the light beams, upon entering the scattering layer, to be scattered rather than reaching the human eyes directly, thereby alleviating the issue of a poor viewing experience caused by light leakage.

In the reflective display 1, the first optical surface 54 located at the lowest point of the groove g, is connected to the second optical surface 56 also at the lowest point of the groove g. The depth D of the groove g falls within the range of 3 micrometers to 10 micrometers. To ensure a lighter weight for the reflective display 1, the thickness T of the front light guide plate 5 is set between 0.2 cm and 0.7 cm. By reducing the overall weight of the reflective display, the cost is lowered, making it more feasible for widespread use.

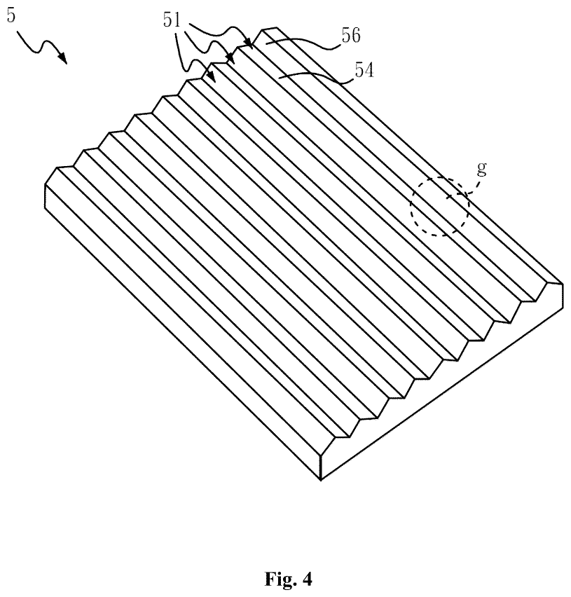

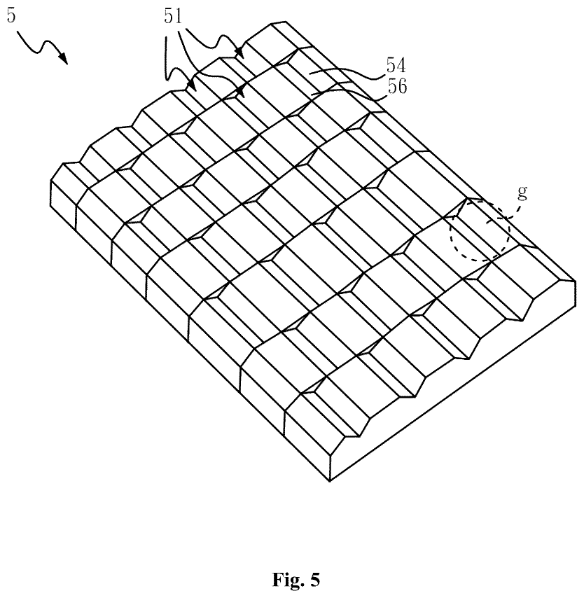

Please refer to FIGS. 4 and 5. FIG. 4 depicts a top view of the first embodiment of the front light guide plate of the present invention, and FIG. 5 illustrates a top view of the second embodiment of the front light guide plate of the present invention. Each of the optical structures on the front light guide plate 5 comprises the second optical surface 56 and the first optical surface 54, which are grooves g formed between the second optical surface 56 and the first optical surface 54. The grooves g can be hole-like or trench-like structures. In FIG. 4, the grooves g are connected in a trench structure resembling a washboard, while in FIG. 5, they are arranged in a neat and organized structure resembling a checkerboard pattern. Both groove structures serve the function of mitigating light leakage.

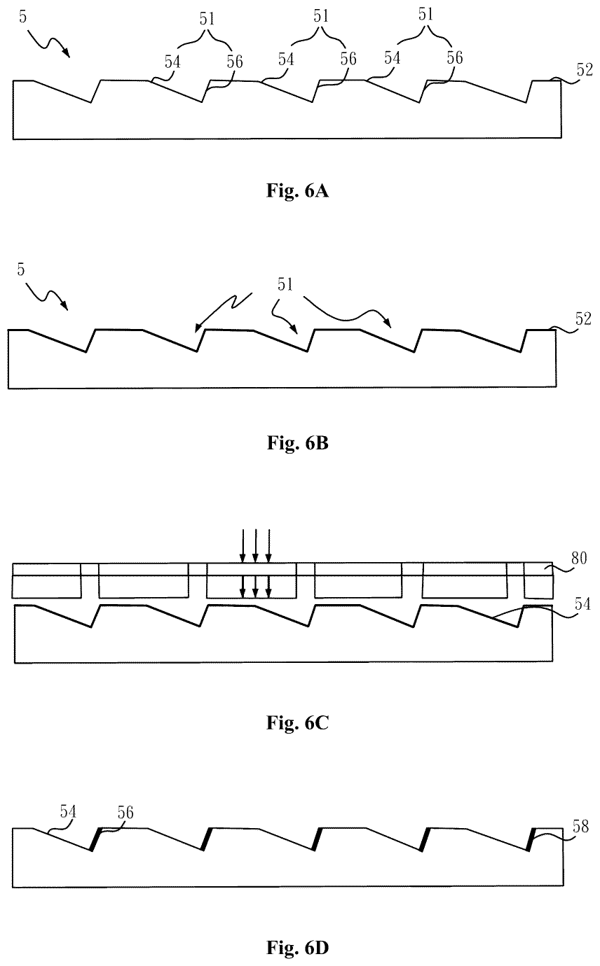

Please refer to FIGS. 6A-6D. FIGS. 6A-6D are step-by-step schematic views of the manufacturing process of the front light guide plate 5 in accordance with the present invention. Compared to the laser dotting method in the prior art, the front light guide plate 5 can have an asymmetrical microstructure, as shown in FIGS. 6A and 6B, using the manufacturing method of the present invention. The method for manufacturing the front light guide plate 5 comprises the following steps. First, the first optical surface 54 and the second optical surface 56 are formed on a material made of polymethyl methacrylate (PMMA), engineering plastics, or other suitable materials using hot embossing or nanoimprinting processes to create the optical structure 51.

Subsequently, the surface of the optical structure 51 is coated with a substance that has light-shielding or light-absorbing properties. This substance can be, for example, a black photoresist. In FIGS. 6C and 6D, a photomask 80 is used to carry out the development process, and the photoresist is selectively removed through an etching process. This leaves only the photoresist with light-absorbing properties on the second optical surface 56, forming the light-reducing layer 58 shown in FIG. 6D, thereby completing the fabrication process of the front light guide plate 5. Alternatively, in place of the steps shown in FIG. 6C, a digital exposure machine can be used without a photomask, treating only the first optical surface 54. This fabrication process results in only the photoresist remaining on the second optical surface 56, which is then cleaned using a developer. In this way, the light-reducing layer 58 is formed on the second optical surface 56.

Furthermore, the light-reducing layer 58 can also be manufactured through physical treatment process such as sandblasting or chemical treatments like etching. These treatment processes create a rough surface that scatters reflected light, effectively reducing visual interference for viewers and mitigating contrast-related issues.

Therefore, the present invention provides a front light guide plate and a reflective display through the design of the optical structure 51 and the light reduction layer 58 of the front light guide plate 5. The majority of light beams emitted by the light source 3 are directed towards the display device 7 and ultimately reflected into the viewers' eyes. Additionally, the light beams refracted from the first optical surface 54 towards the second optical surface 56 are absorbed or scattered by the light-reducing layer 58, thereby reducing the amount of light entering the viewers' eyes. This approach not only enhances the lighting effect and ensures uniform light distribution but also effectively mitigates issues such as light spots, dark corners, and insufficient lighting. Furthermore, it improves image color contrast and conserves energy, thereby solving the light leakage problems associated with conventional light guide plates and significantly enhancing the visual experience for viewers.

The descriptions illustrated above set forth simply the preferred embodiments of the present invention; however, the characteristics of the present invention are by no means restricted thereto. All changes, alterations, or modifications conveniently considered by those skilled in the art are deemed to be encompassed within the scope of the present invention set forth by the following claims.

1. A front light guide plate, comprising a plurality of optical structures implemented on a first surface;
wherein each of the optical structures comprises at least a first optical surface and a second optical surface, which are disposed in face-to-face fashion; and
wherein a first angle is formed between the extension line of the first optical surface and a second surface, which is away from the first surface, and the second optical surface and the first optical surface together form a groove on the first surface, the second optical surface is implemented with a light-reducing layer, and the first optical surface can completely reflect light beams into the second optical surface, and a portion of the light beams that are originally intended to be reflected by the second optical surface from the first optical surface will be absorbed or scattered by the light-reducing layer, and a second angle is formed between the extension line of the second optical surface and the second surface.

2. The front light guide plate according to claim 1, wherein the lowest point of the first optical surface in the grooves are connected to the lowest point of the second optical surface in the grooves.

3. The front light guide plate according to claim 1, wherein the grooves, with depths ranging from 3 to 10 micrometers, is implemented in hole-like or trench-like structure.

4. The front light guide plate according to claim 1, wherein a flat surface is further positioned between the optical structure and another neighboring optical structure, and the two ends of the flat surface are connected respectively to the first optical surface and the second optical surface.

5. The front light guide plate according to claim 1, wherein the first angle is in the range of 3 degrees to 60 degrees.

6. The front light guide plate according to claim 1, wherein, the second angle is in the range of 60 degrees to 100 degrees.

7. The front light guide plate according to claim 1, wherein at least one light source is implemented on at least one side of the front light guide plate, and the light source emits light beams towards the front light guide plate.

8. The front light guide plate according to claim 7, wherein the display device is further disposed on the second surface of the front light guide plate, and the light beams emitted from the light source are reflected by the first optical surface of the front light guide plate and enter the display device.

9. The front light guide plate according to claim 1, wherein the light-reducing layer is a material layer with either a high light absorption rate or high surface roughness to absorb or scatter a portion of the light beams emitted from the first optical surface onto the second optical surface.

10. A reflective display, comprising:
a front light guide plate, comprising a first surface, a second surface arranged corresponding to the first surface, and a plurality of optical structures arranged on a first surface, wherein each of the optical structures comprises:
a first optical surface, wherein a first angle is formed between the extension line of the first optical surface and the second surface; and
a second optical surface, arranged in face-to-face fashion to the first optical surface so that a groove is formed on the first surface, wherein the second optical surface is implemented with a light-reducing layer, and a second angle is formed between the extension line of the second optical surface and the second surface;
at least one light source, implemented on at least one side of the front light guide plate, wherein the light sources emit light beams toward the front light guide plate; and
a display device, disposed at the second surface of the front light guide plate;
wherein the light beams emitted from the light source are completely reflected by the first optical surface of the front light guide plate and enter the display device, and a portion of the light beams emitted from the first optical surface and directed towards the second optical surface is absorbed or scattered by the light reducing layer.

11. The reflective display according to claim 10, wherein the lowest point of the first optical surface in the grooves are connected to the lowest point of the second optical surface in the grooves.

12. The reflective display according to claim 11, wherein the grooves, with depths ranging from 3 to 10 micrometers, is implemented in hole-like or trench-like structure.

13. The reflective display according to claim 10, wherein a flat surface is further positioned between the optical structure and another neighboring optical structure, and the two ends of the flat surface are connected respectively to the first optical surface and the second optical surface.

14. The reflective display according to claim 10, wherein the first angle is in the range of 3 degrees to 60 degrees.

15. The reflective display according to claim 10, wherein, the second angle is in the range of 60 degrees to 100 degrees.
